(19) United States
(12) Patent Application Publication
(10) Pub. No.: US 2026/0108907 A1
(43) Pub. Date: Apr. 23, 2026

(54) PUMP CONTAINER FOR PASTE

(71) Applicant: ANHUI JND PLASTIC PACKAGING Co., LTD., Huainan City (CN)

(72) Inventor: Xinrui ZHANG, Shanghai (CN)

(21) Appl. No.: 19/226,223

(22) Filed: Jun. 3, 2025

Related U.S. Application Data
(63) Continuation of application No. PCT/CN2025/090385, filed on Apr. 22, 2025.

(30) Foreign Application Priority Data
Oct. 23, 2024 (CN) 202411484381.5

(51) Int. Cl. B05C 17/01; B05C 17/005

(52) U.S. Cl. CPC B05C 17/0146; B05C 17/00516

(57) ABSTRACT

A pump container for paste includes a columnar paste tube; a cover; a piston slidably arranged inside the paste tube and in a sealing fit with an inner wall of the paste tube, where a paste spout is fixed on the cover for outputting the paste, a one-way valve is mounted at the paste spout; a one-way paste dispensing mechanism inside the paste tube at the end of the paste tube, and a paste storage chamber is formed between the piston and the one-way paste dispensing mechanism; an elastic rubber bowl located on another end of the one-way paste dispensing mechanism away from the piston, a paste dispensing chamber is formed between the elastic rubber bowl and the one-way paste dispensing mechanism, the paste spout is in communication with the paste dispensing chamber; and a button on the cover for squeezing the elastic rubber bowl.

### CROSS-REFERENCE TO RELATED APPLICATION

This application is a continuation of PCT application Ser. No. PCT/CN2025/090385, filed on Apr. 22, 2025, which claims the priority and benefit of Chinese patent application serial no. 202411484381.5, filed on Oct. 23, 2024. The entirety of PCT application Ser. No. PCT/CN2025/090385 and Chinese patent application serial no. 202411484381.5 are hereby incorporated by reference herein and made a part of this specification.

### TECHNICAL FIELD

The present application relates to the technical field of containers, and, in particular, to a pump container for paste.

### DESCRIPTION OF RELATED ART

Paste is a semi-solid substance with a certain consistency, which is widely used in fields such as medicine, cosmetics, and food. After production, paste is packaged in appropriate containers based on its intended use, to facilitate subsequent sales and application.

Toothpaste is a commonly used paste in daily life. After production, the toothpaste is usually filled in a flexible tube. During use, the toothpaste is extruded onto a toothpaste through squeezing the flexible tube as needed. As living standards continue to rise, people's expectations for quality of life have also increased. The method of squeezing toothpaste from a flexible tube no longer meets the people's expectations for quality of life. Additionally, when the toothpaste is nearly used up, squeezing out the remaining toothpaste requires considerable effort, significantly compromising the user experience.

### SUMMARY

To improve the user experience when extruding toothpaste, the present application provides a pump container for paste, by which the toothpaste can be squeezed out by simply pressing a button during use.

The pump container for paste provided in the present application adopts the following technical solutions.

A pump container for paste includes:
a paste tube configured as a columnar structure;
a cover detachably fixed on an end of the paste tube;
a piston slidably arranged inside the paste tube and in a sealing fit with an inner wall of the paste tube, where a paste spout is fixed on the cover for outputting the paste, a one-way valve is mounted at the paste spout;
a one-way paste dispensing mechanism inside the paste tube at the end of the paste tube with the cover, where the piston is located on a first end of the one-way paste dispensing mechanism away from the cover, and a paste storage chamber is formed between the piston and the one-way paste dispensing mechanism;
an elastic rubber bowl on the end of the paste tube with the cover, the elastic rubber bowl is located on a second end of the one-way paste dispensing mechanism away from the piston, a paste dispensing chamber is formed between the elastic rubber bowl and the one-way paste dispensing mechanism, the paste in the paste storage chamber enters the paste dispensing chamber only through the one-way paste dispensing mechanism, and the paste spout is in communication with the paste dispensing chamber; and
a button on the cover for squeezing the elastic rubber bowl.

By adopting the above technical solution, the elastic rubber bowl and the one-way paste dispensing mechanism are provided inside the paste tube, to form the paste dispensing chamber therebetween. When the paste tube contains paste, the elastic rubber bowl is squeezed when the button is pressed, to increase the pressure within the paste dispensing chamber, thereby extruding the paste within the paste dispensing chamber through the one-way valve, to output the paste from the paste spout. Upon releasing the button, the elastic rubber bowl returns to its original shape, to create a negative pressure within the paste dispensing chamber. Since the one-way valve prevents air from entering the paste dispensing chamber, the paste in the paste storage chamber is drawn into the paste dispensing chamber, which results in a decrease of pressure in the paste storage chamber, so that atmospheric pressure pushes the piston into the paste storage chamber, so as to move the piston in accordance with the paste and maintain the paste storage chamber in a sealed state with constant pressure at all times. During use, the paste can be squeezed out from the paste tube simply by pressing the button, which is convenient and effectively improves the user experience.

Optionally, the one-way paste dispensing mechanism includes a partition plate, a retaining ring and a flap membrane elastically connected to the retaining ring; the partition plate is fixed on the inner wall of the paste tube and is configured with a paste inlet hole through the partition plate, the paste inlet hole is configured to be passed through by the paste; the retaining ring is coaxially fixed on an end of the partition plate close to the elastic rubber bowl; and the flap membrane is mounted on an edge of the paste inlet hole to seal the paste inlet hole.

By adopting the above technical solution, the partition plate and the flap membrane are provided to form a one-way conveying structure inside the paste tube. When a negative pressure is created in the paste dispensing chamber, the flap membrane is drawn into the paste dispensing chamber, thereby connecting the paste inlet hole with the paste dispensing chamber, thereby absorbing the paste in the paste storage chamber into the paste dispensing chamber. After pressure equilibrium is restored between the paste dispensing chamber and the paste storage chamber, the flap membrane gradually returns to its original position under elastic resilience to seal the paste inlet hole. Even if the flap membrane does not completely seal the paste inlet hole, the pressure within the paste dispensing chamber rises when the button is pressed to squeeze the paste dispensing chamber, causing the flap membrane to be pressed tightly against the paste inlet hole, thereby completing the normal output of the paste.

Optionally, the elastic rubber bowl is shaped as a hemisphere and inverted mounted on the partition plate, a fixing sleeve is fixed on the elastic rubber bowl at a position corresponding to the paste spout and is sleeved on the paste spout, a locking ring with backflow prevention is coaxially fixed inside the fixing sleeve, and an inner side of the locking ring with backflow prevention is inclined in a direction away from the paste spout.

By adopting the above technical solution, the elastic rubber bowl is configured as a hemisphere, so as to form a paste dispensing chamber between the elastic rubber bowl and the partition plate, which helps to increase the elasticity of the elastic rubber bowl. The fixing sleeve is provided on the elastic rubber bowl to facilitate connection of the paste spout to the interior of the elastic rubber bowl. The locking ring with backflow prevention is provided on the fixing sleeve, which can prevent the fixing sleeve from falling off the paste spout, while effectively improving the sealing performance between the fixing sleeve and the paste spout.

Optionally, a retaining slot is defined on the inner wall of the paste tube at a position where the partition plate and the elastic rubber bowl are mounted, and an edge of the partition plate and an edge of the elastic rubber bowl are snapped fitted within the retaining slot.

By adopting the above technical solution, the retaining slot is formed on the inner wall of the paste tube, which facilitates the installation of the partition plate and the elastic rubber bowl.

Optionally, the one-way valve includes an elastic valve body coaxially fixed inside the paste spout, the elastic valve body is configured as an elastic barrel-shaped structure with an opening at an end, a paste outlet is formed at the end of the elastic valve body, and side walls of the paste outlet abut against each other for sealing.

By adopting the above technical solution, the paste outlet is formed on the elastic valve body, and the side walls of the paste outlet abut against each other. During use, the paste can force open the side walls of the paste outlet to be output only when the internal pressure exceeds the elastic force of the side walls. Upon approaching pressure equilibrium, the paste outlet will be rapidly resealed.

Optionally, the paste outlet is configured as a cross-shaped opening, and the elastic valve body is provided with an inwardly recessed support portion at a position corresponding to a central angle location of the paste outlet.

By adopting the above technical solution, the paste outlet is configured as the cross-shaped opening, and the support portion is correspondingly provided. One end of the elastic valve body is configured to be conical, so that it is easy for the internal paste to force open the paste outlet. When pressure is applied from the outside to the inside, the paste outlet will be tightly closed under pressure, forming a one-way opening structure.

Optionally, a seal sleeve is fixed on the paste spout to enhance a sealing performance between the one-way valve and the paste spout.

By adopting the above technical solution, with the seal sleeve, the sealing performance between the one-way valve and the paste spout may be improved, thereby preventing leakage.

Optionally, an outlet of the paste spout is inclined toward a first side of the cover, the button is located on a second side of the cover, and the button is hinged to the cover.

By adopting the above technical solution, the paste spout and the button are located on two sides of the cover, which optimizes spatial utilization on the cap while ensuring a neat and orderly layout, thereby enhancing the overall aesthetic appeal.

Optionally, a cover plate for sealing the paste spout is fixed on an end of the button close to the outlet of the paste spout.

By adopting the above technical solution, the cover plate is arranged on the button. When the button is not being pressed, the cover plate seals the outlet of the paste spout, which can prevent external impurities from contaminating the paste.

Optionally, a protective cap is sleeved on the end of the paste tube with the cover.

By adopting the above technical solution, when the product is not in use, the structure on the cover is protected by the protective cap, thereby preventing external impurities from contaminating the paste.

In conclusion, the present application includes at least one of the following beneficial technical effects:
1. The elastic rubber bowl and the one-way paste dispensing mechanism are provided inside the paste tube, to form the paste dispensing chamber therebetween. When the paste tube contains paste, the elastic rubber bowl is squeezed when the button is pressed, to increase the pressure within the paste dispensing chamber, thereby extruding the paste within the paste dispensing chamber through the one-way valve, to output the paste from the paste spout. Upon releasing the button, the elastic rubber bowl returns to its original shape, to create a negative pressure within the paste dispensing chamber. Since the one-way valve prevents air from entering the paste dispensing chamber, the paste in the paste storage chamber is drawn into the paste dispensing chamber, which results in a decrease of pressure in the paste storage chamber, so that atmospheric pressure pushes the piston into the paste storage chamber, so as to move the piston in accordance with the paste and maintain the paste storage chamber in a sealed state with constant pressure at all times. During use, the paste can be squeezed out from the paste tube simply by pressing the button, which is convenient and effectively improves the user experience.
2. The partition plate and the flap membrane are provided to form a one-way conveying structure inside the paste tube. When a negative pressure is created in the paste dispensing chamber, the flap membrane is drawn into the paste dispensing chamber, thereby connecting the paste inlet hole with the paste dispensing chamber, thereby absorbing the paste in the paste storage chamber into the paste dispensing chamber. After pressure equilibrium is restored between the paste dispensing chamber and the paste storage chamber, the flap membrane gradually returns to its original position under elastic resilience to seal the paste inlet hole. Even if the flap membrane does not completely seal the paste inlet hole, the pressure within the paste dispensing chamber rises when the button is pressed to squeeze the paste dispensing chamber, causing the flap membrane to be pressed tightly against the paste inlet hole, thereby completing the normal output of the paste.
3. The paste outlet is configured as the cross-shaped opening, and the support portion is correspondingly provided. One end of the elastic valve body is configured to be conical, so that it is easy for the internal paste to force open the paste outlet. When pressure is applied from the outside to the inside, the paste outlet will be tightly closed under pressure, forming a one-way opening structure.

### BRIEF DESCRIPTION OF THE DRAWINGS

FIG. 1 is a schematic view showing the overall structure of the pump container for paste in the present application;

FIG. 2 is a sectional view of the pump container for paste of the present application;

FIG. 3 is a partial view highlighting the structure of the one-way paste dispensing mechanism;

FIG. 4 is a first schematic view of an elastic valve cap according to a first embodiment of the present application;

FIG. 5 is a second schematic view of the elastic valve cap according to the first embodiment of the present application;

FIG. 6 is a first schematic view of an elastic valve cap according to a second embodiment of the present application;

FIG. 7 is a second schematic view of the elastic valve cap according to the second embodiment of the present application.

### DESCRIPTION OF THE EMBODIMENTS

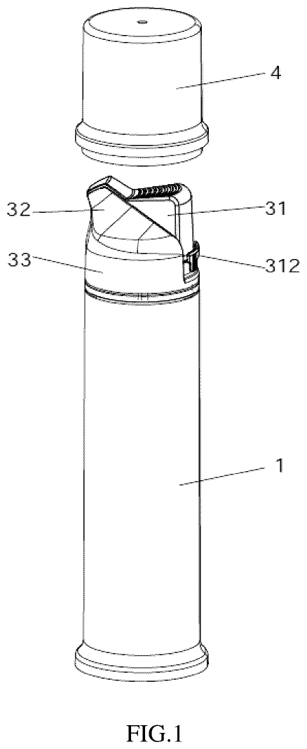

The present application will be described in further detail in combination with FIGS. 1-7.

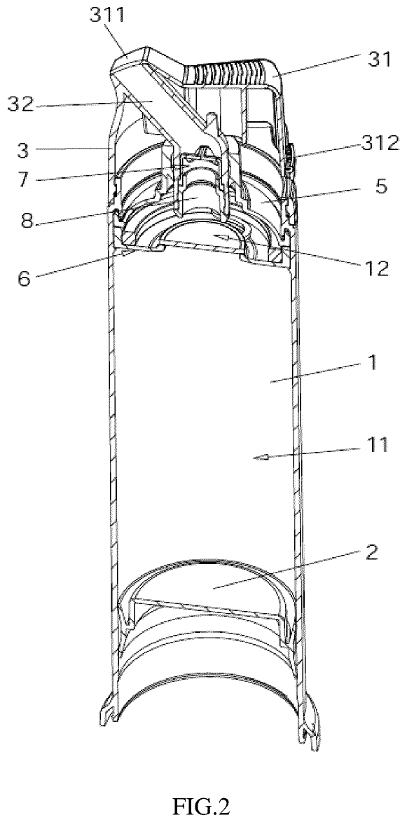

The present application discloses a pump container for paste. Referring to FIGS. 1-2, the pump container for paste includes a paste tube 1, a piston 2, a cover 3, a button 31, and a protective cap 4. The paste tube 1 is a cylindrical container. The piston 2 is coaxially slidable in the paste tube 1, and maintains a seal against an inner wall of the paste tube 1. The cover 3 is detachably installed at one end of the paste tube 1 through a threaded connection or snap-fit connection. A paste spout 32 is integrally formed on one side of the cover 3, while the button 31 is located on the other side thereof and is hinged to the cover 3. The protective cap 4 is sleeved over one end of the paste tube 1 near the cover and encloses the cover 3 inside for protection. During use, it is only necessary to rotate and press the button 31, to extrude the paste in the paste tube 1 through the internal structure, which is convenient for use.

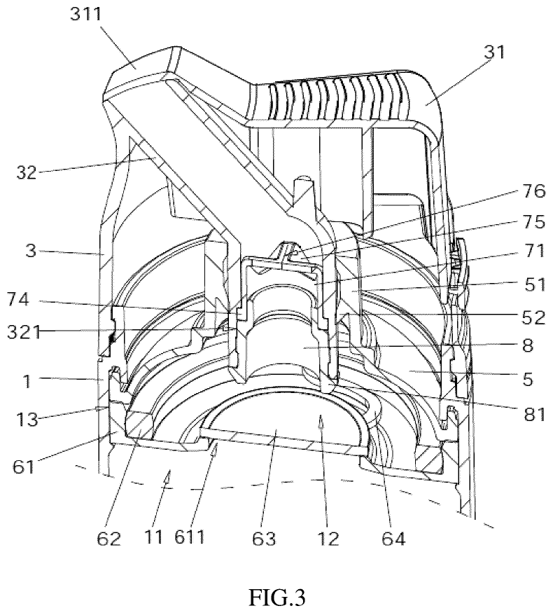

Referring to FIGS. 2-3, the end of the paste tube 1 near the cover 3 is provided with an elastic rubber bowl 5 and a one-way paste dispensing mechanism 6. The elastic rubber bowl 5 is located on the upper surface around and close to the paste spout 32 and is connected to the paste spout 32. The piston 2 is located on the side of the one-way paste dispensing mechanism 6 away from the elastic rubber bowl 5. A paste storage chamber 11 for storing the paste is formed between the one-way paste dispensing mechanism 6 and the piston 2. A paste dispensing chamber 12 is formed between the elastic rubber bowl 5 and the one-way paste dispensing mechanism 6. The paste spout 32 is in communication with the paste dispensing chamber 12, and a one-way valve 7 is installed in the paste dispensing chamber 12.

During use, when rotating and pressing the button 31, it may presses against the elastic rubber bowl 5 downwards, to increase the pressure inside the paste dispensing chamber 12, so that the paste in the paste dispensing chamber 12 is extruded through the one-way valve 7 and discharged into the paste spout 32, thus completing the paste discharge. After releasing the button 31, the elastic rubber bowl 5 may return to its original shape due to its own elasticity. At this time, a negative pressure forms inside the paste dispensing chamber 12, while the pressure the paste storage chamber 11 is maintained at atmospheric pressure. The paste in the paste storage chamber 11 may force open the one-way paste dispensing mechanism 6 and flows into the paste dispensing chamber 12. Meanwhile, the external atmospheric pressure also pushes the piston 2 upward, to compensate space for the paste discharge.

The one-way paste dispensing mechanism 6 includes a partition plate 61 coaxially fixed on the inner wall of the paste tube 1, a retaining ring 62, and a flap membrane 63 elastically connected to the retaining ring 62. The partition plate 61 is a circular plate and is coaxially configured with a paste inlet hole 611 through the partition plate. The retaining ring 62 is coaxially fixed on one side of the partition plate 61 near the elastic rubber bowl 5. The flap membrane 63 is a circular plate, and the circumferential surface thereof is connected with the retaining ring 62 through with an elastic band 64, to coaxially connect the flap membrane 63 at the center of the retaining ring 62. In a free state, the flap membrane 63 abuts against a peripheral surface of the paste inlet hole 611 to seal it.

When the pressure inside the paste dispensing chamber 12 rises, the flap membrane 63 is pressed tightly against the peripheral surface of the paste inlet hole 611 to seal it. When a negative pressure forms inside the paste dispensing chamber 12, the flap membrane 63 is adsorbed into the paste dispensing chamber 12, allowing the paste in the paste storage chamber 11 to enter the paste dispensing chamber 12.

The elastic rubber bowl 5, shaped as a hemisphere, is inverted mounted on the one-way paste dispensing mechanism 6. A fixing sleeve 51 is integrally and coaxially formed at the position of the elastic rubber bowl 5 corresponding to the paste spout 32 and is sleeved over the paste spout 32. A locking ring with backflow prevention 52 is integrally and coaxially formed on the inner wall of the fixing sleeve 51, and the inner side of the locking ring with backflow prevention 52 is inclined in a direction away from the paste spout 32, so as to effectively prevent the fixing sleeve 51 from slipping off the paste spout 32. A retaining slot 13 is formed on the inner wall of the paste tube 1 at the installation positions of the elastic rubber bowl 5 and the partition plate 61. The edges of the elastic rubber bowl 5 and the partition plate 61 are snapped fitted and secured within the retaining slot 13.

The one-way valve 7 includes an elastic valve body 71. The elastic valve body 71 includes a flexible diaphragm 711 and a support column 712. The support column 712 is configured with a through-channel along its axis for the paste to flow through. The flexible diaphragm 711 hermetically covers one end of the support column 712, and the other end of the support column 712 is provided with a support portion 75 to be inserted into the paste spout 32.

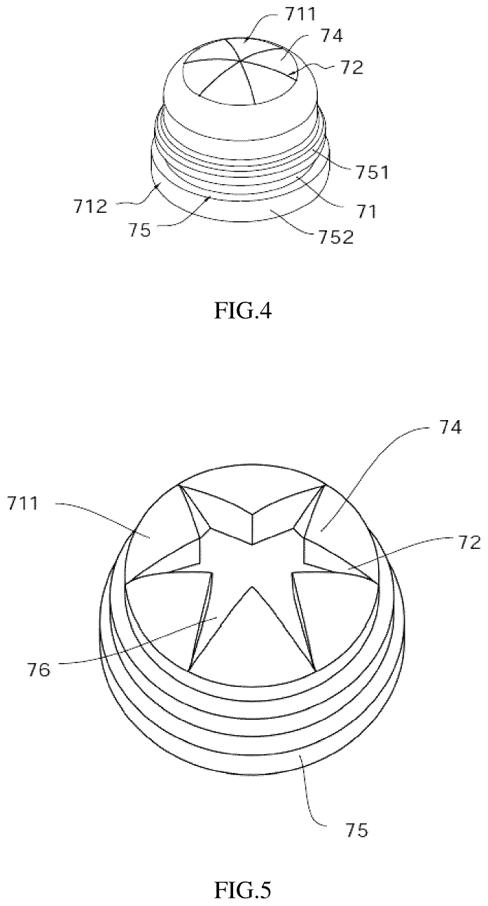

In one embodiment, referring to FIGS. 4-5, the flexible diaphragm 711 has a centrally convex arc-shaped surface. The flexible diaphragm 711 is configured with several slits 72 that extend radially outward from its center. In different embodiments, the number of slits 72 can range from 3 to 8. In the present embodiment, 6 slits 72 are provided, which are evenly distributed around the axis of the support column 712 in the circumferential direction. The slits 72 divide the flexible diaphragm 711 into a plurality of deformable and reversible reset flaps 74. The reset flaps 74 naturally close to form a sealing structure when not pressurized. When an upward positive pressure is formed inside when pressing the past pump, the reset flaps 74 flip outward and open to form a star-shaped paste outlet 76, allowing the paste to flow out of the through-channel.

In the present embodiment, the reset flap 74 is a three-dimensional elastic sheet-like structure enclosed by the slits 72. It can deform under pressure and return to its initial closed state through the inherent elasticity of the material after the pressure is released. This structure ensures that the outlet remains tightly sealed when the paste pump is not in operation, thereby preventing air or impurities from entering the container. Additionally, it can respond promptly by opening under pump pressurization, thereby improving the paste dispensing efficiency and neatness. In different embodiments, the three-dimensional structure of the reset flap 74 can be dome-shaped, conical, spherical cap-shaped, or a gradient curved surface structure, the curvature thereof can be adjusted depending on application requirements to meet different response times by opening or deformation requirements.

Furthermore, the flexible diaphragm 711 can gradually thicken, thin, or maintain a uniform thickness from the edge to the center. In an exemplary embodiment, the flexible diaphragm 711 gradually thins from the periphery to the center, so that the central area is more prone to deformation under pump pressurization, thereby enhancing the sensitivity of opening.

The sidewall of the support column 712 is connected to the flexible diaphragm 711 via an arcuate transition, avoiding sharp corners or sharp edges, which helps to improve the overall mechanical stress distribution, so as to prevent fatigue damage to the material during repeated deformation, thereby prolonging the service life. In terms of material selection, both the support column 712 and the flexible diaphragm 711 can be made of an elastic material, such as silicone, which not only may meet the requirements for good elastic recovery performance but also has good temperature resistance, chemical resistance, and food-contact safety. In different embodiments, the elastic material can be silicone or other polymer materials, such as rubber or polyurethane. Any non-toxic polymer material that is capable for restoring to close the slits 72 after deformation is acceptable.

In different embodiments, the structural form of the slits 72 may also be varied. In addition to the basic straight radial slit 72, they can also be an arc-shaped slit 72, segmented polygonal slit 72, or a composite slit 72 with preset recessed segments, to modify the flipping behavior and adjust the opening pressure threshold of the reset flaps 74. The depth of the slits 72 can be configured as fully penetrating or semi-penetrating. In the semi-penetrating configuration, a controllable diaphragm thickness is retained at the bottom of the slit 72, thereby forming a single-use opening structure upon initial activation.

The support portion 75 is disposed at one end of the support column 712 away from the flexible diaphragm 711. Specifically, the support portion 75 is an elastic clamping portion on the outer side surface of the support column 712. The support portion 75 is provided with two protruding limiting collars around the axis thereof and on its side surface. The two protruding limiting collars are opposite each other, forming a retaining slot between them to be engaged with the plug-in component of the toothpaste pump body. When inserted into the pump body, the protruding limiting collars slightly and elastically deform to provide a reliable clamping force and automatically rebound to their positioning state after release.

Optionally, the two protruding limiting collars are respectively defined as a first protruding limiting collar 751 and a second protruding limiting collar 752. One side of the first protruding limiting collar 751 close to the flexible diaphragm 711 is connected to the support column 712 via an arcuate transition, while one side away from the flexible diaphragm 711 is configured with a right-angle junction, serving as an anti-retraction stopper. One side of the second protruding limiting collar 752 close to the flexible diaphragm 711 is connected to the outer wall of the support column 712 at an angle, providing initial guidance and elastic preload during insertion into the pump body.

In different embodiments, the first protruding limiting collar 751 may be connected with the support column 712 via a bevel transition or a curved surface transition. A locally thickened structure may also be considered to enhance the non-retraction function. The second protruding limiting collar 752 may also use a rounded-corner connection or a flexible rib structure to improve adaptability to the insertion force. In another optional embodiment, the retaining slot between the two protruding limiting collars can also be configured with a reinforcing rib or a flexible inner lip structure to improve insertion sealing performance and enhance the connection stability.

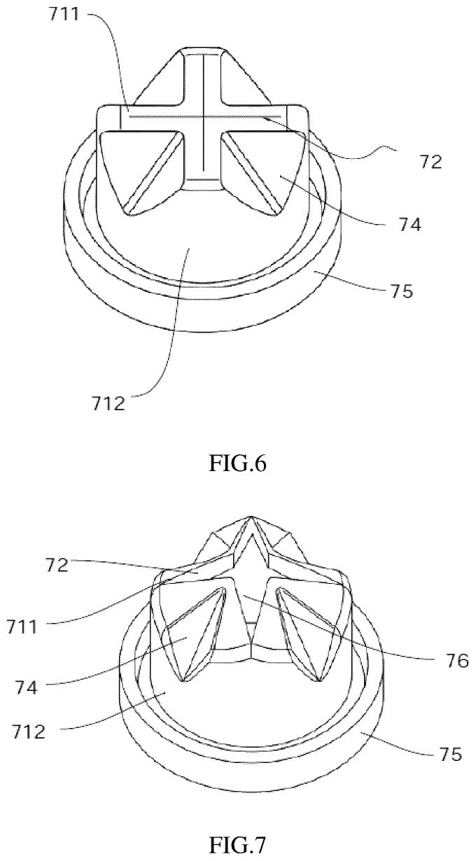

In another embodiment, referring to FIGS. 6-7, the slits 72 include two perpendicular slits 72 intersecting at the center of the flexible diaphragm 711 to form a cross-shaped structure. These two slits 72 divide the flexible diaphragm 711 into four symmetric reset flaps 74. The adjacent edges of each reset flap 74 are defined by two adjacent slits 72, and the bottom edge thereof is connected to the edge of the support column 712, forming a unit that can elastically flip under pressure.

In an exemplary embodiment, the middle area on a side of each reset flap 74 away from the intersection center of the slits 72, together with the adjacent support column 712, is jointly recessed into the interior of the support column 712, thus forming an inwardly-curved support portion 75 at this location, so that two sides of the support portion 75 naturally form arc-shaped segments with a slightly triangular profile. The above structure remains in a naturally closed state under no pressurization, and symmetrically flips to open along the direction of the slits 72 under positive pressure. A paste outlet 76 similar to a cross-shaped star pattern is formed among the four reset flaps 74. Specifically, during use, the support portion 75 can support the paste outlet 76, to open the paste outlet 76 when squeezed by the paste in the paste dispensing chamber. When the paste outlet 76 is squeezed in the opposite direction, the support portion 75 will support the paste outlet 76, making the paste outlet 76 squeeze inward for sealing, thus forming a one-way paste outlet structure.

Optionally, the flexible diaphragm 711 forms a cross-shaped planar structure in the non-recessed region. This cross-shaped plane is mirror-symmetrical with respect to the slits 72 and lies co-planar in an undeformed state, which helps to ensure secure contact of the reset flaps 74 in the closed state while maintaining structural stability.

Furthermore, to enhance the elastic response performance of the regions of the reset flaps 74, the recessed region and the non-recessed region are connected via an arc-shaped transition, so that the reset flap 74 may have a continuous deformation path when it flips to open, thus avoiding material fatigue or fracture caused by localized stress concentration.

In other embodiments, the flexible diaphragm 711 and the support column 712 may be integrally formed or fixedly connected with each other by hot-melting welding or plug-in connection, etc. The appropriate structural form may be selected based on the specific mold process requirements.

In a further exemplary scheme, the slits 72 may also be configured as three or four intersecting slits, forming a six-flap or eight-flap structure, to meet the discharge requirements of higher flow rates or viscosity-specific pastes. In another variant embodiment, the recessed part of the reset flap 74 may also be configured as a polygonal curved surface, a gradual thickness transition structure, or a multi-segment curvature configuration, to adjust the opening angle and rebound speed.

A seal sleeve 8 is provided on the paste spout 32 at the position corresponding to the one-way valve 7. The seal sleeve 8 is coaxially inserted into one end of the paste spout 32 near the seal groove 321. One end of the seal sleeve 8 near the one-way valve 7 extends into the one-way valve 7. An annular protrusion is integrally formed on the seal sleeve 8 at the position corresponding to the seal groove 321 and is inserted into the seal groove 321, effectively improving the sealing performance between the seal sleeve 8 and the paste spout 32. A protruding sealing collar 81 is integrally formed on the seal sleeve 8 near the end of the paste spout 32. The protruding sealing collar 81 mounted on one end of the paste spout 32 located inside the elastic rubber bowl 5, effectively preventing the paste from entering a gap between the seal sleeve 8 and the paste spout 32.

A cover plate 311 is integrally formed at one end of the button 31 close to the outlet of the paste spout 32. When the button 31 is in a free state, the cover plate 311 is located on one end of the paste spout 32 to seal it, preventing external impurities from entering the paste. At one end of the button 31 away from the cover plate 311, a seal strip 312 is fixed to the outer side wall of the button 31 close to the cover 3. The product is equipped with the seal strip 312 at the factory, which must be torn off before use, providing a clear indicator to verify whether the product has been used.

The implementation principle of the pump container for paste, as disclosed in the embodiment of the present application, is as follows. The elastic rubber bowl 5, the one-way paste dispensing mechanism 6 and the one-way valve 7 are provided, to divide the cavity inside the paste tube 1 into a paste storage chamber 11 and a paste dispensing chamber 12. When the elastic rubber bowl 5 is pressed through the button 31, the paste in the paste storage chamber 11 is squeezed and output through the one-way valve 7. When the elastic rubber bowl 5 resets, the paste in the paste storage chamber 11 is drawn into the paste dispensing chamber 12. The overall structure is simple and convenient to use, thereby effectively improving the user experience.

The above are all the exemplary embodiments of the present application, and the protection scope of the present application is not limited thereby. Therefore, all equivalent changes made in accordance with the structure, shape and principle of the present application shall be covered within the protection scope of the present application.

### LIST OF REFERENCE SIGNS

1 paste tube
11 paste storage chamber
12 paste dispensing chamber
13 retaining slot
2 piston
3 cover
31 button
311 cover plate
312 seal strip
32 paste spout
321 seal groove
4 protective cap
5 elastic rubber bowl
51 fixing sleeve
52 locking ring with backflow prevention
6 one-way paste dispensing mechanism
6 partition plate
611 paste inlet hole
62 retaining ring
63 flap membrane
64 elastic band
7 one-way valve
71 elastic valve body
711 flexible diaphragm
712 support column
72 slit
74 reset flap
75 support portion
751 first protruding limiting collar
752 second protruding limiting collar
76 paste outlet
8 seal sleeve
81 protruding sealing collar

What is claimed is:

1. A pump container for paste, comprising:
a paste tube configured as a columnar structure;
a cover detachably fixed on an end of the paste tube;
a piston slidably arranged inside the paste tube and in a sealing fit with an inner wall of the paste tube, wherein a paste spout is fixed on the cover for outputting the paste, and a one-way valve is mounted at the paste spout;
a one-way paste dispensing mechanism inside the paste tube at the end of the paste tube with the cover, wherein the piston is located on a first end of the one-way paste dispensing mechanism away from the cover, and a paste storage chamber is formed between the piston and the one-way paste dispensing mechanism;
an elastic rubber bowl on the end of the paste tube with the cover, the elastic rubber bowl is located on a second end of the one-way paste dispensing mechanism away from the piston, a paste dispensing chamber is formed between the elastic rubber bowl and the one-way paste dispensing mechanism, the paste in the paste storage chamber enters the paste dispensing chamber only through the one-way paste dispensing mechanism, and the paste spout is in communication with the paste dispensing chamber; and
a button on the cover for squeezing the elastic rubber bowl.

2. The pump container for paste according to claim 1, wherein the one-way paste dispensing mechanism comprises a partition plate, a retaining ring and a flap membrane elastically connected to the retaining ring, the partition plate is fixed on the inner wall of the paste tube and is configured with a paste inlet hole through the partition plate, the paste inlet hole is configured to be passed through by the paste, the retaining ring is coaxially fixed on an end of the partition plate close to the elastic rubber bowl, and the flap membrane is mounted on an edge of the paste inlet hole to seal the paste inlet hole.

3. The pump container for paste according to claim 2, wherein the elastic rubber bowl is shaped as a hemisphere and invertedly mounted on the partition plate, a fixing sleeve is fixed on the elastic rubber bowl at a position corresponding to the paste spout and is sleeved on the paste spout, a locking ring with backflow prevention is coaxially fixed inside the fixing sleeve, and an inner side of the locking ring with backflow prevention is inclined in a direction away from the paste spout.

4. The pump container for paste according to claim 2, wherein a retaining slot is defined on the inner wall of the paste tube at a position where the partition plate and the elastic rubber bowl are mounted, and an edge of the partition plate and an edge of the elastic rubber bowl are snapped fitted within the retaining slot.

5. The pump container for paste according to claim 1, wherein the one-way valve comprises an elastic valve body coaxially fixed inside the paste spout, the elastic valve body is configured as an elastic barrel-shaped structure with an opening at an end of the elastic valve body, a paste outlet is formed at the end of the elastic valve body, and side walls of the paste outlet abut against each other for sealing.

6. The pump container for paste according to claim 5, wherein the paste outlet is configured as a cross-shaped opening, and the elastic valve body is provided with an inwardly recessed support portion at a position corresponding to a central angle location of the paste outlet.

7. The pump container for paste according to claim 1, wherein a seal sleeve is fixed on the paste spout to enhance a sealing performance between the one-way valve and the paste spout.

8. The pump container for paste according to claim 1, wherein an outlet of the paste spout is inclined toward a first side of the cover, the button is located on a second side of the cover, and the button is hinged to the cover.

9. The pump container for paste according to claim 8, wherein a cover plate for sealing the paste spout is fixed on an end of the button close to the outlet of the paste spout.

10. The pump container for paste according to claim 1, wherein a protective cap is sleeved on the end of the paste tube with the cover.
